(19) United States
(12) Patent Application Publication
(10) Pub. No.: US 2006/0269905 A1
(43) Pub. Date: Nov. 30, 2006

(54) Method for preparing tooth structure for bonding

(76) Inventor: Stefan S. Krisch, Corpus Christi, TX (US)

Correspondence Address: GIFFORD, KRASS, GROH, SPRINKLE & CITKOWSKI, P.C, PO BOX 7021, TROY, MI, 48007-7021, US

(21) Appl. No.: 11/136,781

(22) Filed: May 25, 2005

(51) Int. Cl. A61C 5/00

(52) U.S. Cl. 433/215

(57) ABSTRACT

The present invention discloses a method for preparing tooth structure, such as dentin and enamel, for bonding with a composite material. The method includes the steps of creating a first fluid stream laden with an abrasive material, such as aluminum oxide and a second liquid stream. The fluid streams are directed towards the tooth structure so that the abrasive material laden fluid stream and liquid stream both impinge upon the tooth structure and roughen it for enhanced bonding with composite material.

### BACKGROUND OF THE INVENTION

I. Field of the Invention

The present invention relates generally to dental procedures and, more particularly, to a dental procedure for preparing tooth structure for bonding with composite material.

II. Description of the Prior Art

When decay is removed from tooth structure, such as dentin and enamel, the resulting cavity caused by the removal of the tooth decay must be filled in order to protect the tooth from further decay, infection and the like. Both amalgam and composites have been used to fill the cavity preparation performed by the dentist.

When amalgam is used to fill the cavity preparation performed by the dentist, the dentist typically undercuts the enamel thus forming a pocket in the tooth having a relatively small opening exposed to the exterior of the enamel. Amalgam is then forced into the pocket and is held in place by a mechanical retention with the tooth structure. Although amalgam has proven adequate in filling cavity preparations, it is cosmetically undesirable due to its silver or dark color.

There are, however, composites and other similar materials (hereinafter collectively referred to as composites or composite materials) which are of the same color as the tooth and are used to fill the cavity preparation performed by the dentist when removing the tooth decay. Since these composites are of the same color as the tooth, they are cosmetically more desirable than amalgam.

In order to prepare the tooth structure, i.e. the enamel and dentin and associated tooth material, an acid is typically used to etch the enamel to enhance the bond between the composite and the enamel. The dentin, however, should not be etched because of problems with pulpal insult from acid which can result in increased pulpal sensitivity and other complications.

Consequently, in order to protect the dentin from the acid etch, the dentin is first covered with a primer which not only protects the dentin from the acid during a subsequent enamel etch, but also removes the smear layer caused by the traditional rotary drill used by dentists.

After the dentin has been coated with the primer, an acid etch is then used to etch the enamel surrounding the opening in the tooth structure. FIG. 1 depicts such an acid etch at approximately 3500 magnification. As can be seen from FIG. 1, the acid etch in the enamel caused large crevices and peaks in the enamel.

After the acid etch, the acid is rinsed away with liquid and the tooth is dried. After drying, a bonding agent is applied to both the dentin as well as the etched enamel. The composite is then applied to the dentin and etched enamel on top of the bonding agent, cured with a light whereupon the composite restoration is completed.

There are, however, a number of disadvantages with this previously known process for cavity preparation for composites. One disadvantage is that the entire procedure for cavity preparation using a composite is a time consuming and relatively difficult procedure for the dentist.

A still further disadvantage of the previously known procedure is that it is very difficult, if not altogether impossible, for the dentist to apply the primer only to the dentin while leaving the enamel surrounding the cavity preparation exposed for the subsequent acid etch. This is particularly true since the dentin-enamel junction forms only a fine line oftentimes difficult for the dentist to see. Consequently, as a practical matter, the bonding is applied by the dentist not only to the dentin but also to portions of the enamel. Any primer applied to the enamel, however, will prevent the desired acid etch of the enamel and thus degrade the overall integrity of the bonding between the enamel and the composite.

A still further disadvantage of the previously known cavity preparation for composites is that the acid etch creates relatively deep crevices and high peaks in the area of the enamel which is etched as shown in FIG. 1.

While the deep crevices and high peaks of the enamel caused by the acid etch enhance the overall bond between the composite and the enamel, moisture from the rinse following the acid etch can become entrapped in the crevices. Any remaining moisture entrapped within the crevices of the acid etch from insufficient drying weakens the bond between the composite and the enamel.

A still further disadvantage of these previously known cavity preparations for composites is that the polymerization process of the composite places varying magnitudes of stress upon the bond between the dentin and the composite. Such stresses can result in increased sensitivity between the composite and the dentin, especially where gaps exist between the composite and the dentin. Such gaps can result in small movement of the composite when the patient chews or otherwise applies pressure to the composite which also results in increased sensitivity for the tooth.

A still further disadvantage of the previously known cavity preparation using acid etch on the enamel is that gaps frequency result between the composite and the enamel due to the large peaks and valleys in the enamel from the acid etch. These gaps increase the risk of microleakage which allows contaminants to infiltrate the gaps in the enamel and cause additional decay of the tooth from the microleakage.

### SUMMARY OF THE PRESENT INVENTION

The present invention provides a method for cavity preparation for composites and similar materials which overcomes all of the above mentioned disadvantages of the previously known methods.

In brief, the present invention comprises the step of creating a first fluid stream laden with abrasive material and a second liquid stream wherein the liquid is preferably water or a water-based solution. Preferably aluminum oxide is utilized as the abrasive material and the aluminum oxide has an average size of between 2 and 100 microns. Although any fluid for the abrasive laden stream can be used, preferably air is used.

Both the abrasive material laden fluid stream and liquid stream are then directed towards the tooth structure, i.e. both the enamel and the dentin, so that both streams intersect a predetermined distance from the handpiece and impinge upon the tooth structure and roughen it. Furthermore, by maintaining the impingement of the abrasive material laden fluid stream and liquid stream on the dentin for a sufficient time, the streams appear to close the tubules in the dentin thereby resulting in decreased tooth sensitivity.

Following roughening of the tooth structure by the abrasive material laden stream and liquid stream, the dentist applies both the bonding and the composite to the tooth structure and cures the composite in the conventional fashion thus completing the tooth restoration.

### BRIEF DESCRIPTION OF THE DRAWING

A better understanding of the present invention will be had upon reference to the following detailed description when read in conjunction with the drawing in which:

FIG. 1 is a side diagrammatic view illustrating a handpiece for performing the method of the present invention; and

FIG. 2 is a flowchart illustrating the preferred embodiment of the present invention.

### DETAILED DESCRIPTION OF A PREFERRED EMBODIMENT OF THE PRESENT INVENTION

The present invention provides an improved method for surface modification and preparation following removal of tooth decay for use with composite restorations. Furthermore, as used herein, the term “composites” includes veneers, resins, glass ionomers, ceramics, porcelain and similar materials. Such materials are typically attached to the tooth by a bonding material, as well as mechanical adhesion to the teeth structure.

With reference now to FIG. 2, the dentist first performs a cavity preparation at step 10 in order to prepare the cavity for subsequent bonding with the composite. The cavity preparation at step 10, i.e. removal of the tooth decay, can be performed either conventionally, such as with a rotary drill, or through other means, such as with a laser, an air abrasive system or the like.

Following the cavity preparation at step 10, both the dentin and a portion of the enamel surrounding the opening in the tooth are exposed. It is this opening and adjacent enamel (not shown) which will be subsequently filled and/or covered by the composite.

In accordance with the present invention, following the cavity preparation at step 10, a fluid stream laden with abrasive material is created or initiated by the dentist at step 12 using any conventional equipment. Such equipment typically uses air as the fluid and aluminum oxide as the abrasive material. Typically, pressurized air is used to create the air flow and preferably the pressure of the pressurized air is variably controlled by the dentist between 20-200 psi. The aluminum oxide of the present invention has an average size of between 2 and 100 microns although other types and sizes of abrasive material can alternatively be used.

Substantially simultaneously with step 12, a liquid stream is also created at step 13. The liquid is preferably water or a water-based solution.

After creating or initiating the abrasive material laden fluid stream and liquid stream, the dentist directs the abrasive material laden fluid stream and liquid stream toward a target site on the tooth structure at step 14 which will undergo restoration with a composite. Furthermore, the dentist directs the streams so that the abrasive material and liquid both impinge on the tooth structure, i.e. dentin and surrounding enamel, which roughens the tooth structure in preparation for the composite.

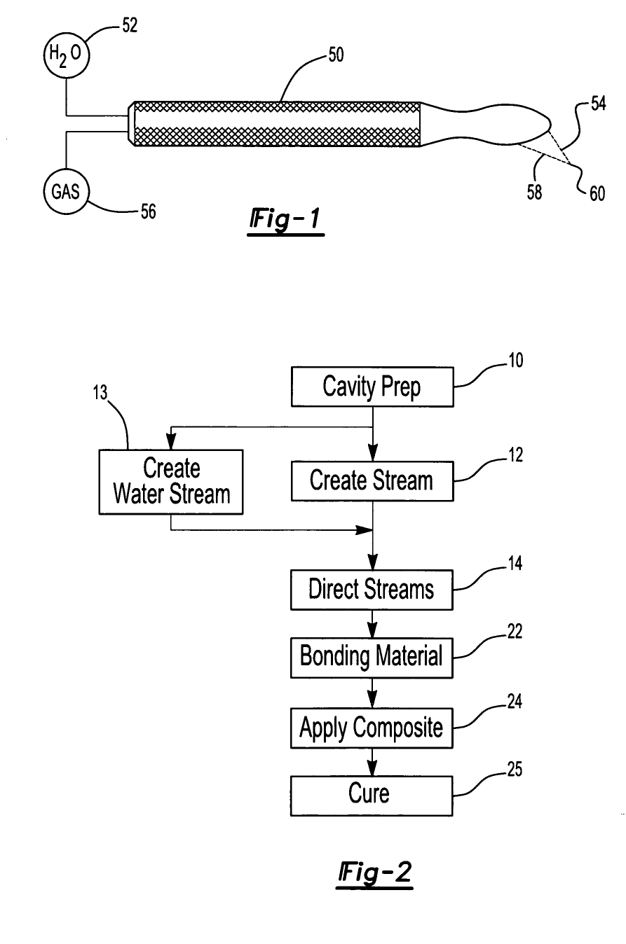

With reference now to FIG. 1, an exemplary handpiece 50 is shown which is dimensioned to be hand held by the dentist. A pressurized liquid source 52 is fluidly connected to the handpiece 50 and, when activated by any conventional means, produces a liquid stream 54 which projects outwardly from the handpiece 50. Similarly, a pressurized gas source 56 laden with abrasive particles is also fluidly connected to the handpiece 50 and, when activated by any conventional means, produces an abrasive grit laden gas stream 58 which projects outwardly from the handpiece 50. The streams 54 and 58 intersect at a predetermined point 60 relative to the handpiece 50. In practice the handpiece 50 is positioned so that the point 60 is positioned on the target site on the tooth for the dental procedure.

Furthermore, the tubules in the dentin are exposed to the surface of the dentin. In sharp contrast to this, the area roughened by the abrasive material appears to close or otherwise cover the tubules and it is believed that this results in decreased sensitivity of the dentin.

With reference again to FIG. 2, after the tooth structure including both the dentin and the enamel have been roughened at step 14, the dentist then applies a bonding material to the tooth structure at step 22 and subsequently applies the composite to the bonding material at step 24. The composite is then cured at step 26 and the restoration is completed.

The method of the present invention can also be used to remove tooth structure, e.g. caries, through the simultaneous impingement of the liquid stream and abrasive particle laden gas stream.

The method of the present invention thus achieves numerous advantages over the previously known methods for bonding composites to tooth structure. First, since the acid etch of the enamel is completely eliminated, it is no longer necessary for the dentist to protect the dentin by coating the dentin with a primer prior to the acid etch. This not only saves time for the dentist, but also eliminates the previously known problem of unintentionally applying the primer to areas of the enamel where etching was desired.

A still further advantage of the present invention is that, since the acid etch has been eliminated, it is no longer necessary to wash the acid from the tooth structure following the acid etch. As such, with the present invention, it is no longer necessary to dry the tooth structure of liquid following the surface modification of the tooth structure. Likewise, since the liquid rinse has been eliminated, the likelihood of entrapped moisture on the tooth structure and the previously known resulting degradation of the composite bond is also eliminated.

A still further advantage of the present invention is that the composite material is bonded not only to the enamel as in the previously known methods, but also to the dentin. Such bonding of the composite to the dentin effectively eliminates any gaps which may be present between the composite and the dentin thus performing a firmer bond and support between the composite and the dentin. This firmer bond reduces the likelihood of sensitivity caused by small movement of the composite relative to the dentin.

It is believed that a still further advantage of the present invention is that the abrasive material effectively closes the tubules present in the dentin prior to restoration of the tooth. By closing the tubules, the likelihood of sensitivity of the tooth is further diminished.

Furthermore, the relatively small peaks and valleys, as contrasted with an acid etch, caused by the method of the present invention in the enamel and dentin reduces the possibility of microleakage through gaps between the composite and the tooth structure. This not only provides a better bond between the composite and the tooth structure, but also minimizes the risk of microleakage.

From the foregoing, it can be seen that the present invention provides a novel method for cavity preparation for composites. It has also been found that by using a less abrasive material, such as sodium bicarbonate, entrained in the fluid stream, the fluid stream with the less abrasive material can be used to clean teeth, remove plaque and tartar and the like. As with the cavity preparation, the sodium bicarbonate is preferably entrained within an air flow stream. Having described my invention it can be seen that the present invention provides a novel means of preparing a cavity preparation for composites, as well as cleaning teeth. Having described my invention, however, many modifications thereto will become apparent to those skilled in the art to which it pertains without deviation from the spirit of the invention as defined by the scope of the appended claims.

1. A method for preparing a tooth structure for bonding with a composite material comprising the steps of:
creating a gas fluid stream laden with abrasive material;
creating a liquid stream; and
directing said streams towards the tooth structure for a time sufficient so that the abrasive material laden fluid stream impinges upon the tooth structure.

2. The invention as defined in claim 1 wherein said tooth structure comprises dentin and enamel wherein said directing step comprises the step of directing the impingement of the abrasive material laden fluid stream and liquid stream simultaneously against both the enamel and the dentin.

3. The invention as defined in claim 1 wherein said abrasive material comprises aluminum oxide.

4. The invention as defined in claim 3 wherein said abrasive material has an average size of between two and one hundred microns.

5. The invention as defined in claim 1 wherein said gas fluid is air.

6. The invention as defined in claim 5 wherein said step of creating a fluid stream comprises the step of using a compressed air source and varying the pressure of the compressed air source.

7. The invention as defined in claim 6 wherein said pressure varies from twenty to two hundred psi.

8. The invention as defined in claim 1 wherein said tooth structure includes exposed tubules and further comprising the step of maintaining impingement of the abrasive material laden fluid stream on the tooth structure for a time sufficient to close said tubules.

9. The invention as defined in claim 1 wherein said abrasive material comprises sodium bicarbonate powder.

10. The invention as defined in claim 1 wherein said liquid comprises water.

11. A method for restoration of tooth structure using a composite comprising the steps of:
creating a gas fluid stream laden with abrasive material and a liquid stream, directing said streams towards the tooth structure for a time sufficient so that the abrasive material laden fluid stream and liquid stream both impinge upon the tooth structure at a target site and roughen the tooth structure;
thereafter applying a bonding material on the tooth structure that has been roughened;
thereafter applying composite to the bonding material; and
curing the bonding material.

12. The invention as defined in claim 11 wherein said bonding material applying step is performed immediately following said directing step.

13. The invention as defined in claim 11 wherein said tooth structure comprises dentin and enamel wherein said directing step comprises the step of directing the impingement of the abrasive material laden fluid stream against both the enamel and the dentin.

14. The invention as defined in claim 11 wherein said abrasive material comprises aluminum oxide.

15. The invention as defined in claim 14 wherein said abrasive material has an average size of between two and one hundred microns.

16. The invention as defined in claim 11 wherein said fluid is air.

17. The invention as defined in claim 11 wherein said tooth structure includes exposed tubules and further comprising the step of maintaining impingement of the abrasive material laden fluid stream on the tooth structure for a time sufficient to close said tubules.

18. The invention as defined in claim 11 wherein said liquid comprises water.

19. A method for preparing a tooth structure for bonding with a composite material comprising the steps of:
creating a gas fluid stream laden with abrasive material;
creating a liquid stream;
directing said gas fluid stream and liquid stream towards the tooth structure for a time sufficient so that the abrasive material laden fluid stream and liquid stream impinge upon the tooth structure and roughen the tooth structure;
wherein said tooth structure includes exposed tubules and further comprising the step of maintaining impingement of the abrasive material laden fluid stream and liquid stream on the tooth structure for a time sufficient to close said tubules.

20. The invention as defined in claim 19 wherein said liquid comprises water.

21. A method for removing a tooth structure comprising the steps of:
creating a gas fluid stream laden with abrasive material;
creating a liquid stream;
directing said fluid stream towards the tooth structure for a time sufficient so that the abrasive material laden fluid stream impinges upon the tooth structure and remove the tooth structure.
